(19) United States
(12) Patent Application Publication
(10) Pub. No.: US 2004/0085982 A1
(43) Pub. Date: May 6, 2004

(54) Apparatus and method for queue assignment for each link in multi-links of an access pointer controller

(75) Inventor: Jeong Hoon Choi, Naju-si (KR)

Correspondence Address: FLESHNER & KIM, LLP, P.O. BOX 221200, CHANTILLY, VA, 20153, US

(73) Assignee: LG Electronics Inc.

(21) Appl. No.: 10/676,052

(22) Filed: Oct. 2, 2003

(30) Foreign Application Priority Data
Oct. 7, 2002 (KR) 10-2002-0060960

(51) Int. Cl. H04L 12/28

(52) U.S. Cl. 370/412; 370/419

(57) ABSTRACT

A system and method for managing traffic in a communication system assigns multiple links in a system to a queue. The queue is formed from one or multiple memories and a queue assignment unit assigns banks in the queue to one or more links. The queue assignment also writes data in the banks of specific links through a write control signal. A signal detection unit detects availability of a line interface unit, and a data control unit that reads data from the queue and writes it in the line interface unit. Through this structure, a faster and more efficient data transmission system is formed.

### BACKGROUND OF THE INVENTION

1. Field of the Invention

The present invention relates to a communication system, and more particularly to a system and method for controlling queuing of data transmitted in a communication system.

2. Background of the Related Art

FIG. 1 illustrates a related-art mobile telecommunication system. This system includes a mobile station 1 (MS1) that conducts wireless packet data communication using a terminal, mobile station 2 (MS2) that conducts voice and packet data communication, and multiple access pointers (APs) 1a˜1n in that support wireless connection between the mobile stations MS1 and MS2. This system also includes an access pointer controller (APC) 3 that manages wireless resources of the multiple access pointers 1a˜1n with multi-links, a central ATM network (CAN) 5 that matches and manages the APCs, and a packet data serving node (PDSN) 7 that supports packet data communication service.

IN operation, mobile stations MS1 and MS2 conduct wireless access to access pointers 1a˜1n and request the packet data service node to provide packet data services through the access point controller 3 and the CAN 5, thereby establishing links. The packet data serving node 7 transmits multicast/broadcast packet data requested by the relevant subscriber.

The CAN transmits the packet data to the relevant access pointer controller 3. This access pointer controller manages multiple access pointers 1a˜1n with multi-links and transmits the packet data to the access pointers 1a˜1n. Thus, the access pointers 1a˜ provide packet data services to the mobile stations MS1 and MS2.

Each access pointer controller 3 has a structure wherein multiple access controllers 1a˜1n are connected to the access pointer controller with multi-links. The access pointer controller records data in queues and transmits the recorded data to access pointers 1a˜1n through the relevant links.

FIG. 2 illustrates the multi-link queue assignment structure in an access pointer controller of the related art. This structure includes a queue assignment unit 100 that detects address fields of data destined for a specific link of the relay lines and writes the data in the relevant queue 101a˜101n, a signal detection unit 110 that detects an empty signal (ES) of queues 101a˜101n and a TCA (Transmit Cell Available) signal of an associated line interface unit (LIU), and a data control unit 120 that reads the data stored in the queue 101a˜101n using the signal received from the signal detection unit 110 and writes it into respective ones of the line interface units 131a˜101n. The queues 101a˜101n correspond one-to-one to the relay lines and are implemented by designing n queues on a board having n links. Now, the multi-link queue assignment structure is explained with references to FIG. 2.

In order to process burst data in multi-links, queues are assigned for relevant links using appropriate memory elements. In other words, one queue is assigned to one link. Thus, data assigned to a specific link goes through the queue of that link. The relay lines are mapped in one-to-one correspondence with queues. If a multi-link board has n links, n queues are therefore required.

In this structure, a FIFO (First In First Out) queue is typically used as a memory element. A FIFO queue assigned to each link makes the program regarding data's empty signal (ES) and full signal (FS) possible, but because its size is fixed. The size of a queue cannot be changed unless the FIFO queue is changed.

As illustrated in FIG. 2, the queue assignment unit 100 extracts address fields of data destined to a specific link of relay lines and records the data in the relevant queue 101a˜101n assigned to the destination link. The signal detection unit 110 detects an empty signals of queue and TCA Transmit Cell Available) signals of line interface units 13a˜131n. The data control unit reads the data stored in the queue 101a˜101n using the signal received from the signal detection unit 110 and writes it in the line interface units 131a˜101n.

The TCA (Transmit Cell Available) signal indicates the availability of FIFO memory within the line interface units 131a˜131n. If FIFO memory is available, this means that the line interface units 131a˜131n are prepared to receive data from the FIFO memory and to upload the data on the relay line.

The queue assignment unit 100 and the data control unit 120 include n WEN/RENs (Write Enable/Read Enable Signals) and data buses in order to control n queues 101a˜101n. The signal detection unit 110 recognizes whether each of the queues is empty or full through the empty signal (ES) or the full signal (FS).

The queue assignment unit 100 detects the address field of data destined to a specific link of the relay lines and writes the data in a relevant one of the queues 101a˜101n assigned to the destination link. The queue assignment unit has a bus structure connected to n queues matched to n links in one-to-one correspondence. The full signal (FS) and the write enable signal (WEN) for controlling the bus are managed as destination addresses.

The full signal is generated at each queue when data has been written in the queue up to the maximum size of the queue. The write enable signal (WEN) is assigned to each queue for the queue assignment unit to control the enable/disable operation of the data bus. The FS and WEN have their unique sequences.

The queue assignment unit 100 also manages the FS and the WEN as destination addresses. The default value of the WEN is the disabled state.

The queue assignment unit checks whether received data may be written in the relevant queue 101a˜101n by detecting the relevant queue's state through the FS. Further, it detects the destination address field of the received data, prepares for the queue assignment, and checks the FS. If the FS indicates that the queue is not full and thus a queue assignment is possible, the WEN for the relevant address is enabled and the received data is loaded on the data bus. If the FS indicates that the queue is full with data, received data is discarded because no further data can be written in the queue 101a˜101n. If data is written in the queue 101a101n, the queue 101a˜101n generates the ES and outputs it to the signal detection unit 110, indicating that the queue 101a˜101n's empty state has been converted to non-empty state.

The general line interface units 131a˜131n have small FIFO memory for each link. This FIFO memory generates the TCA (transmit Cell Available) signal to indicate whether it is possible to load data for the relevant link If the TCA signal indicates the available state, it means that data may be transmitted to the relevant link.

The signal detection unit 110 detects the ES of each queue 101a˜101n and the TCA of a relevant one of the line interface units 131a˜131n and transmits information on the queue's not-empty state and the availability of the line interface unit to the data control unit 120. The data control unit receives information on the not-empty state of the queue and the availability of the line interface unit detected at the signal detection unit 110. Also, the data control unit reads data from the queue and writes data in the line interface unit at the same time.

As with the queue assignment unit, the signal detection unit and the data control unit manage the sequence of the queues 101a˜101n and the line interface units 131a˜131n as addresses.

Data paths between the queues and the line interface units are formed by the bus structure. The read enable signal (REN) for reading the queue 101a˜101n and the WEN of the line interface units 131a˜131n are managed at the data control unit 120 as addresses. The data control unit 120 enables the REN for the address whose queue is in the not-empty state and whose corresponding line interface unit is available for loading. The data control unit writes the data that it has read in the line interface unit at the same time.

The above-described structure of the related art has a number of significant drawbacks. First, because of the one-to-one mapping of links and queues, as the number of links in a multi-link board increases, the number of required queues will also increase. Such increased queues occupy a large amount of space in the multi-link board and also necessarily increases the size of the data bus.

Second, because the size of the data bus is larger, the problem of fan-out needs to be dealt with.

Third, the WEN of the queue assignment unit 100 and the REN of the data control unit 120 must be managed for each and every link respectively.

Fourth, because the size of the queue for the relevant relay line may not be adjusted flexibly, it is difficult to process burst data that may arise at a variable data rate in the network. Increasing the size of the queue in order to solve this problem would result in reducing the speed in the relay line and the delay in transmitting data stored in the queue. In other words, there is a trade-off between the size of queue and the delay in the network. Also, an increased queue size means greater cost.

Fifth, if a specific link in a multi-link board is not used, the queue assigned for such idle link is also not used and thus the queue efficiency is lowered.

### SUMMARY OF THE INVENTION

An object of the present invention is to solve at least the above problems and/or disadvantages and to provide at least the advantages described hereinafter.

In order to solve the above-described problems, the present invention provides a flexible queue assignment apparatus and method in multi-links of an access pointer controller, which may collectively manage and assign all of the queues for links by connecting at least one memory device (SRAM/DPRAM) for links and queues.

Further, the present invention provides a flexible queue assignment apparatus and method in multi-links of an access pointer controller, which may generate the write pointer/read pointer by using address of each relevant bank in banks flexibly assigned to links and thus generate empty signal and full signal, transmit state of the relevant queue, read data recorded in the queue depending on the queue's state and write it in the line interface unit at the same time.

To achieve these and other advantages, the present invention provides a flexible queue assignment apparatus in multi-links of an access pointer controller comprising a queue for implementation of multi-links that integrate and connect multiple memories; a queue assignment unit that assigns banks to links flexibly and writes data in the banks of specific links through write control signal; a signal detection unit that detects availability of a line interface unit and generates full signal and empty signal to notify the state of queue for each link upon receiving write pointer and read pointer; and a data control unit that reads data from the queue and writes it in the line interface unit according to the availability of the line interface unit and the empty signal received from the signal detection unit.

Preferably, the memory is DPRAM or SRAM and the number of banks corresponds to the combination of address bits of the memory. The queue assignment unit compares the number of links and the number of banks and assigns at least one bank to each link. The signal detection unit generates empty signal and full signal for the queue of each link by using write pointer and read pointer of the address of the relevant link if data has been written in or read from such address and reports the state of the queue to the queue assignment unit and the data control unit.

According to another preferred embodiment, the present invention provides a flexible queue assignment apparatus in multi-links of an access pointer controller, which has multi-links to access pointers in a mobile communication system, comprising: a means for writing data that includes a queue integrating and connecting multiple memories for multi-links within the access pointer controller and writes data upon assigning banks of the queue for the multi-links; a means for reporting states that notifies whether data has been written in or read from the queue; and a writing means that writes the data read from the banks of the queue in the FIFO memory within the line interface unit so that the data may be transmitted to the access pointers.

The present invention provides a flexible queue assignment method in multi-links of an access pointer controller comprising: the queue assignment unit's assigning at least one banks for multiple links; if there arises data to be written in a specific link, writing the data in the relevant queue through the relevant write address and write enable signal; each time data is written, increasing address of the queue and transmitting write pointer corresponding to said address to the signal detection unit; the signal detection unit's comparing read pointer of the data control unit and write pointer of the queue assignment unit, generating empty signal and full signal and transmitting them to the data control unit; and depending on the availability of the line interface unit and the empty state of the queue, the data control unit's reading data from the queue and writing it in the line interface unit.

Assigning of banks for multiple links comprises: selecting the first link, checking whether the link is used in the board, and if the link is used, checking whether the next link is used as increasing the link count until the last link is checked; if the first link is not used, assigning a desired number of banks to the link and assigning start address and end address to the link; and beginning with the link immediately following said assigned link until the last link has been processed, assigning banks to the relevant link by increasing start address and end address of the relevant link by referring to the end address of the immediately preceding link.

Writing of data in the relevant queue comprises: initiating address-related parameters of each link from the first link to the last link; if the initialization is completed through the last link, starting read algorithm; checking whether there exists one item of data to be written in the relevant queue beginning with the first link until the last link has been checked; if there exists data to be written, writing the data by using write address and write enable signal and increasing total address when the writing is completed; setting write pointer with the increased total address, transmitting the write pointer to the signal detection unit and checking whether the current address of the link is the highest address of the bank by referring to the total address; and if the current address is the highest address, toggling write carry for the next link, assigning the lowest bits to the total address, or if the current address is not the highest address, checking whether there is data for the next link.

Preferably, the address-related parameters are link start address, link end address, total address and write carry. In the case where the current address of the link has not reached the highest address of the bank, if the restart condition arises, the present invention further comprises initiating address-related parameters of each link.

Generating an empty signal comprises determining the range of each link, from the first link to the last link, comparing write carry and read carry sequentially and calculating the difference between write pointer and read pointer, and checking the existence of data through the value of the difference of the pointers and generating empty signal accordingly by making transition to the empty or not-empty state. The range of each link indicates the number of banks assigned to each link and is determined by using start address and end address of each link.

Further, generating a full signal comprises determining the range of each link, from the first link to the last link comparing write carry and read carry sequentially and calculating the difference of pointers according to the comparison, and if the write carry and the read carry are the same, generating full signal with the full or not-full state depending on whether said difference of pointers is within certain user-specified range.

Difference of pointers is calculated by subtracting the read pointer from the write pointer if the write pointer and the read pointer are the same or if the write pointer and the read pointer are not the same, by calculating the difference of the write pointer and the read pointer reflecting the range of link.

The reading of data from the queue comprises: checking whether the empty signal is in the not-empty state from the first link to the last link; if certain link is detected to be in the not-empty state, reading data through read address and read enable signal connected to the queue; increasing read address and total address by the number of data items that have been read and checking whether the current address of the link is equal to the highest address of the bank; and if the current address of the link is equal to the highest address, toggling read carry and initializing total address with the lowest address of the bank, thereby moving to the next link.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

FIG. 1 illustrates multi-link connection between access pointer controllers and access pointers in the related art.

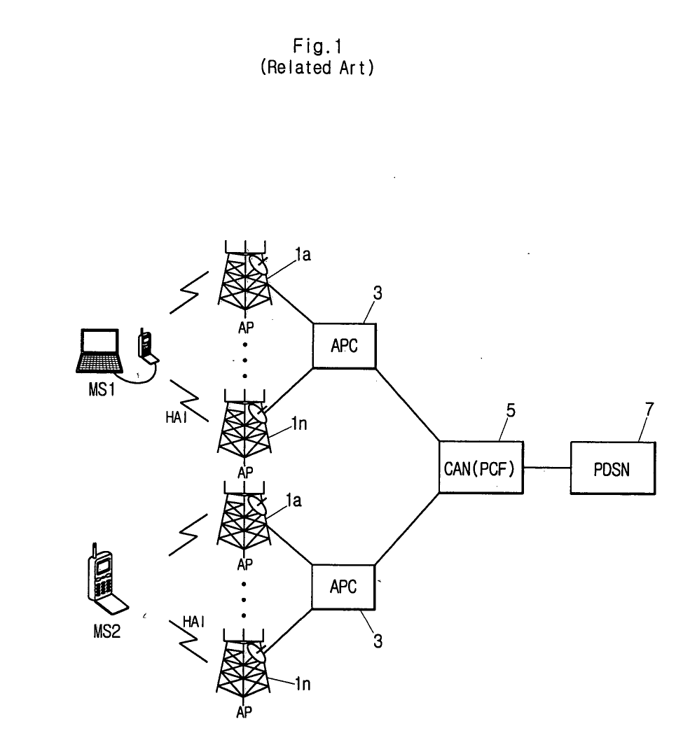

FIG. 2 is a block diagram illustrating a queue assignment apparatus for multi-links of an access pointer controller in the related art.

FIG. 3 is a block diagram illustrating a queue assignment apparatus for multi-links of an access pointer controller according to a preferred embodiment of the present invention.

FIG. 4 illustrates banks and address of the memory according to a preferred embodiment of the present invention.

FIG. 5 is a flow chart that illustrates the flexible queue assignment method in multi-links of an access pointer controller according to a preferred embodiment of the present invention.

FIG. 6 is a flow chart that illustrates the bank assignment method for a link according to a preferred embodiment of the present invention.

FIG. 7 is a flow chart that illustrates the data writing method of the queue assignment unit according to a preferred embodiment of the present invention.

FIG. 8 is a flow chart that illustrates the data reading method of the data control unit according to a preferred embodiment of the present invention.

FIG. 9 is a flow chart that illustrates the empty signal detection method of the signal detection unit according to a preferred embodiment of the present invention.

FIG. 10 is a flow chart that illustrates the full signal detection method of the signal detection unit according to a preferred embodiment of the present invention.

FIG. 11 is a block diagram that illustrates a queue assignment apparatus for links in multi-links of an access pointer controller according to another preferred embodiment of the present invention.

### DETAILED DESCRIPTION OF PREFERRED EMBODIMENTS

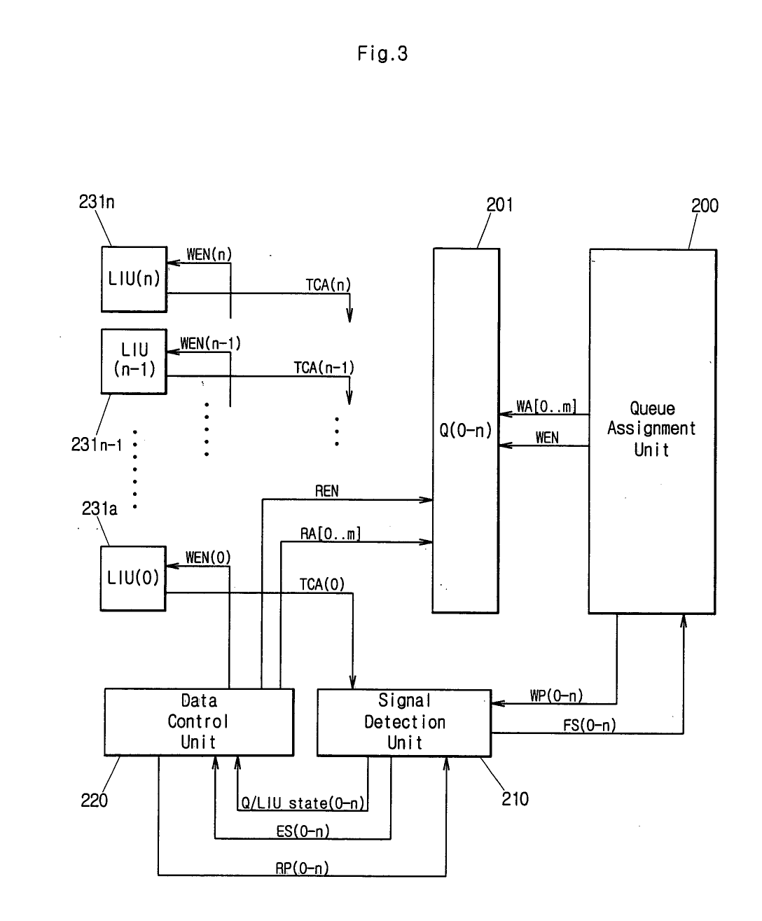

FIG. 3 illustrates a flexible queue assignment apparatus in of an access pointer controller according to a preferred embodiment of the present invention. This apparatus includes a queue assignment unit 200, a signal detecting unit 210, and a data control unit 220. The queue 201 connects multiple links and is formed from one or more memories. The queue assignment unit 200 assigns at least one bank in the queue for each link, writes data in the queue for relevant links, transmits write pointer and write carry of each relevant link to the signal detection unit 210, and detects full signal of each relevant link. The signal detection unit 210 detects write enable signal (WEN) of line interface units 231a˜231n and notifies the data control unit 220 accordingly, receives write pointer (WP) and read pointer (RP), and generates and outputs empty signal (ES) and full signal (FS) for each relevant link thereby reporting the state of the queue. The data control unit 220 receives from the signal detection unit 210 WEN and ES signals from the line interface units 231a˜231n, and reads data if data has been written in the queue 201 and writes the read data in the line interface unit 231a˜231n at the same time.

A detailed explanation of the flexible queue assignment apparatus and method in multi-links of an access pointer controller is provided hereinafter. The queue 201 is constructed using one or more memory devices. The queue does not have a structure wherein a memory device is mapped one-to-one for links and queues as is the case in the related art. If two or more memory devices are used, memory devices are preferably connected by a cascade connection. In other words, the queue is implemented upon integrating all of the queues for links.

The one or more memory devices in the queue are DPRAM (Dual Port RAM) or SRAM (Synchronous RAM) devices (hereinafter, collectively referred to as “DPRAM”). A DPRAM does not generate the same type of empty signal (ES) or full signal (FS) as in a general FIFO structure. Instead, a certain area flexibly assigned to a relevant link (hereinafter, “bank”) generates write pointer/read pointer (WP, RP) signals using the address of the relevant bank, and their signals are used to create an empty signal or full signal. The operation of writing in or reading from banks assigned to links is performed using write enable signals (WENs), read enabled signals (RENs), and addresses of the relevant banks.

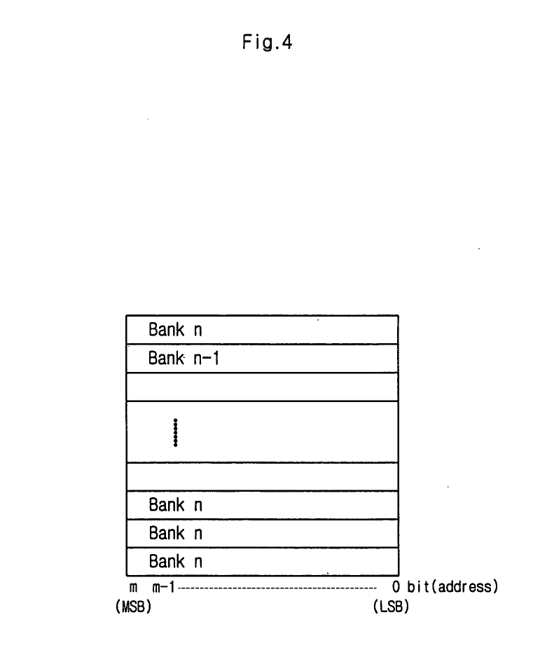

FIG. 4 illustrates a preferred structure of the banks and their addresses for constructing the queue. Each bank is composed of the most significant bit (MSB) of the DPRAM address (bit m) and bits located right to the MSB. The number of banks is indicated by the address, and the number of bits in the address determines the number of banks. For example, if the MSB (bit m) and bit m-1 and bit m-2 (three (3) bits) are used, there would be eight (8) banks (2 to the power of 3). If the combination of three bits (bits m, m-1, and m-2) are 000, it is bank 0, if the combination is 001, it is bank 1, . . . if the three bits are 111, it is bank 7. The number of banks is 2 to the power of the number of address bits (the MSB and bits that are right to the MSB). In this manner, the number of banks may be made equal or greater than the number of links implemented on the multi-link board. If the number of banks and the number of links are the same, one bank maybe assigned to each link. If the number of banks is greater than the number of links, one or more banks may be assigned to one link.

Further, addresses other than the upper addresses (for example, bits m, m-1, and m-2) constituting banks work as addresses of the relevant banks and play the role of write/read pointer (WP/RP). Preferably, pointers are created for each link. If a certain address of a link is written or read, the address is used as the write pointer/read pointer (WP/RP) and generates empty/full signal (ES/FS) for the relevant queue of the link.

The functions of the elements in the flexible queue assignment apparatus will now be discussed. The queue assignment unit 200 assigns flexibly banks for the queue 201 of each link, writes data in the queue of the relevant link transmits write pointer (WP) and write carry that arise at this time to the signal detection unit and detects full signal (FS(0-n)) for each link inputted from the signal detection unit.

The signal detection unit 210 detects TCA signals from the line interface units 231a˜231n and thereby informs the data control unit 220 of the availability of relevant ones of the line interface units, receives write pointer (WP) and read pointer (RP) respectively from the queue assignment unit 200 and the data control unit 220, generates empty signal (ES) and full signal (FS(0-n)), and transmits the signals (FS, ES) to the queue assignment unit 200 and the data control unit 220 respectively, thereby reporting the state of the queue 201.

The data control unit 220 receives from the signal detection unit 210 information indicative of the availability of the line interface units as well as an empty signal (ES) of the queue 201. If the queue 201 is empty, it is determined that there is no relevant data in the queue. If the queue is not-empty, it is determined that data has been written in the queue 201 and the data control unit conducts the operation for reading the data.

The data control unit also receives from the line interface units information indicative of the availability of the line interface units and empty signal (ES) of the queue. If the availability and the non-empty state are satisfied at the same time, the data control unit 220 reads data from the queue 201 using a read enable signal (REN) and read address (RA) and writes the read data in one or more relevant line interface units by outputting write enable signal (WEN). This operation is explained in further detail as follows.

In order to build the queue for n links on a board accommodating multiple links (n links), the queue assignment unit 200 forms the integrated queue 201 using one or more DPRAMs, applies the queue flexibly for relevant links, and writes data in the queue for relevant links. Then, the relevant state information is transmitted to the data control unit 220 by the signal detection unit 210. The data control unit reads data from the queue 201 assigned for the relevant link and writes the read data to the line interface unit.

For this purpose, the queue assignment unit 200 assigns banks for the multi-links. If there exists data to be written for a particular link, the queue assignment unit 200 writes the data to the queue 201 using write address (WA[0 . . . m]) and write enable signal (WEN; WEN0˜WENn). If one item of data is written, the address of the queue 201 is increased by 1 and this write address (WA) becomes the write pointer (WP) and is transmitted to the signal detection unit 210.

The signal detection unit 210 receives read pointer (RP) from the data control unit 220. At this time, because there is no data that has been read, the read pointer for every link is at the initialized state (RP=0).

The signal detection unit than compares the write pointer (WP) whose value has been increased by ‘1’ with the read pointer (RP) at the initialized state, transitions the empty signal (ES) which has been the empty state to the non-empty state and sends it to the data control unit 220. As the availability of the line interface unit and the non-empty state of the queue 201 are satisfied at the same time, the data control unit reads data from the queue and writes it in one or more line interface units.

The present invention repeats the above-described operations. Each portion of the present invention preferably includes an algorithm for conducting the relevant operation. Detailed explanation of the individual operations will be given hereinafter through the explanation of each portion's operation and relevant algorithm.

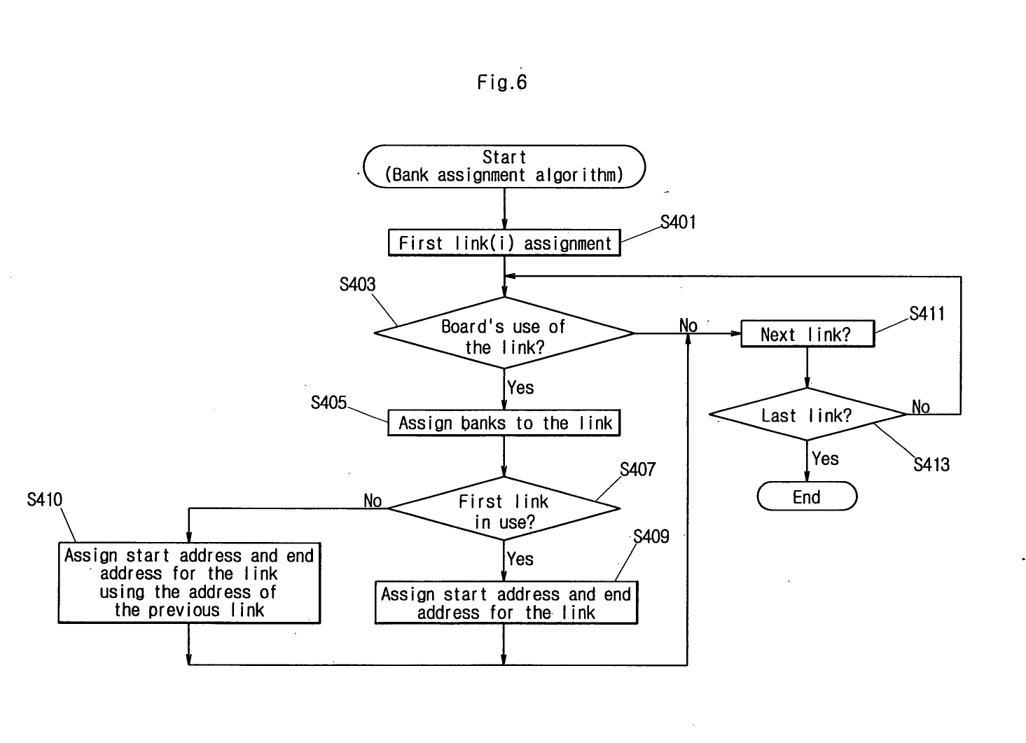

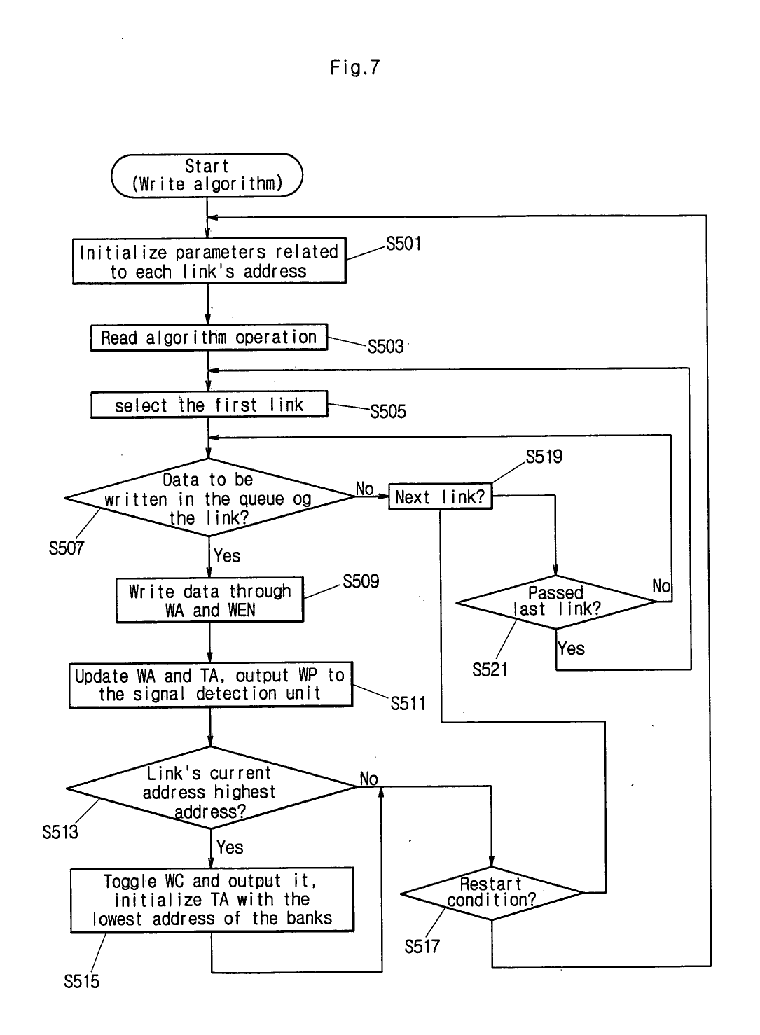

The queue assignment unit 200 operates according to the algorithm set forth in FIG. 6 for bank assignment for links and according to the algorithm of FIG. 7 for writing data in the queue. The write pointer (WP) and the write carry (WC) generated according to the write algorithm are transmitted to the signal detection unit 210. The queue's state is recognized upon receiving a full signal of each link from the signal detection unit 210.

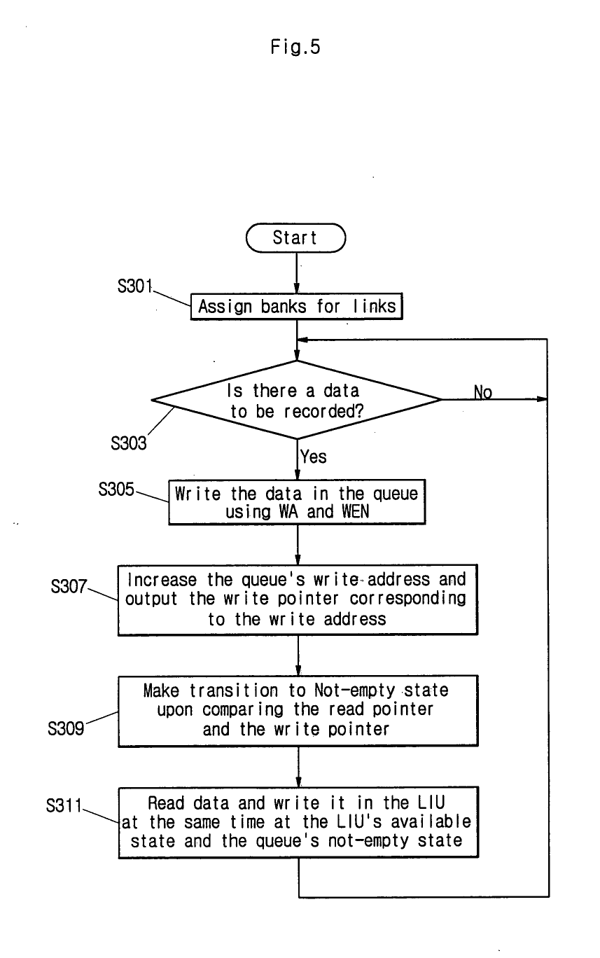

The flexible queue assignment method which maybe performed in an access pointer controller according to the present invention is as illustrated in FIG. 5.

Finally, the queue assignment unit 200 assigns at least one bank for each link of the multi-links (S301). If there arises data to be written for a particular link (S303), the queue assignment unit 200 writes the data in queue 201 through the write address and the write enable signal (S305).

Each time data is written, the queue's address (WA) is increased and the write pointer (WP) corresponding to the address is transmitted to the signal detection unit 210 (S307). The signal detection unit 210 compares the read pointer (RP) from the data control unit and the write pointer (WP) of the queue assignment unit 200, makes transition of the empty state to the not-empty state and transmits this information to the data control unit 220 (S309). If the line interface unit is available and if the queue is not-empty, the data control unit 220 reads the data from the queue 201 and writes it in the line interface unit (S311).

The queue assignment unit's queue assignment algorithm for each link is illustrated in FIG. 6. If the multi-link board accommodates n links, banks are assigned for each link (0-n). The initial value is set for the assignment for the first link (i) (S401). Depending on whether the first link (i) is used in the board, it is determined whether to assign banks for that link (S403). Here, i indicates that it is the first link. The initial value is 0.

Upon checking whether the first link (i) is used or not (S403), if the first link (i) is not used, the link count is increased (i=i+1). This is repeated until i becomes n (S403, S411, S413).

On the other hand, if the first link (i) is used, the desired number of banks are assigned to it (S405). Then, it is checked whether the currently assigned link is the first link that is available (S407). If it is the first link that is available, the queue assignment unit assigns the start address (‘0000’) and the end address of said link (S409).

If the start address is ‘0000’ (S_add=‘0000’), the start address (S_add) is the start address of the DPRAM/SRAM corresponding to the relevant link S_add(i) indicates the start address of the i'th link.

The end address (E_add) is the end address of the DPRAM/SRAM corresponding to the relevant link. E_add(i) indicates the end address of the i'th link. The end address of the first link (E_add(i)) is S_add(i)+(number of banks of the link-1).

When the bank assignment for the first link is completed, the link count is increased (i=i+1) for the next link and the above-described bank assignment is repeated until it comes to the last link (n) (S403˜S415).

In step S407, if the currently assigned link is not the first link that is available for use, the start address for the currently assigned link is assigned by referring to the start address of the previous link. The end address is assigned by using this start address. In other words, the start address S_add(i) for a link that is not the first link becomes E_add(k)+1. The end address E_add(i) is S_add(i)+(number of banks of the link-1). Then, the bank address for each link is assigned until it comes to the last link. When it is the last link, the bank assignment algorithm is terminated (S413).

When the bank assignment for links is completed, depending on the existence of data for relevant link's queue, the operation of writing the data in the queue is conducted.

FIG. 7 illustrates the algorithm of writing data in the queue when there exists data to be written for the relevant link's queue. As illustrated in FIG. 7, for the write algorithm, the address-related parameters for each link are initialized (S501). For this purpose, the start address (SA:S_add) and the last address (EA:E_add) are set as the start address of the relevant link (LSA: Link Start Address) and the end address of the link (LEA: Link End Address) respectively. Of the address of DPRAM/SRAM, all of the extra total address (ETA) bits other than the LSA are set with ‘0.’ Because there is no data written yet, the write carry (WC) is ‘0.’

At this time, if at first the algorithm is commenced without affecting the write/read operations of the relevant link or if the restart condition arises, the start address (SA) and the end address (EA) are transmitted to the link start address/link end address (LSA/ESA).

When all of the parameters of the write algorithm are initialized, the read algorithm is commenced to initialize the read algorithm (S503). This is to enable writing and reading at the same time. Then, beginning with the first link (i=0), it is checked whether data arises for the queue of the link (S505, S507). This is repeated until there arises data to be written in a particular link (S507, S519, S521).

In step S507, if one or more items of data to be written in the queue 201 of a particular link arose, the queue assignment unit 200 writes the data by using the write address (WA) and the write enable signal (WEN) connected to the queue 201 (S509). The number of data items written in this step may be specified freely.

The write address (WA) increases corresponding to the number of data items written. When the operation of writing data is completed according to the specified number of data item, the total address (TA) is increased by 1. The write pointer (WP) is set with said total address (TA) and is transmitted (S511).

The total address is formed as the address combining the LSA and the ETA of the DPRAM/SRAM. For example, if the DPRAM/SRAM has 17 address bits and if the LSA and the ETA are ‘0010’ and ‘0 0000 0000 0000’ respectively, the total address (TA) would be ‘0 0100 0000 0000 0000.’

Then, it is determined whether the current address of the link reached the highest address (S513). In other words, it is determined whether data has been written in all addresses of the relevant link by comparing the link's current address with the total address (TA) indicating the highest address, which is a combination of the link's end address (LEA) and the lower address bits (ETA).

In said step S513, if it is determined that the banks' highest address has been reached, when all of the data has been written in the relevant banks, the write carry (WC) is toggled (WC β Not WC(i)) and is transmitted to the signal detection unit 210. Then, for writing for the next link, the link start address and the lower address bits are set with ‘0’, i.e., these bits are initialized with the lowest address of the banks (S515).

The write carry/read carry (WC/RC) is generated if the total address which has been located in the end address of the assigned link (LEA) when the relevant link was writing or reading data converts to the start address of the link (LSA) after the writing or reading action has been completed. This signal is toggled (0à1à0à1) whenever the WC/RC is generated.

Thereafter, it is determined whether the restart condition has arisen by checking whether the queue (201) assignment structure of the link has been changed during the board's operation (S517). If restart is required, the algorithm is restarted from the first step S501. If the write algorithm is restarted, the read algorithm is restarted as well. In contrast, if no restart condition has occurred, the next step is to check whether any data has arisen to be written in the queue 201 of the next link.

As described above, the queue assignment unit 200 transmits write pointer (WP) and write carry (WC) of each link to the signal detection unit 210 through the bank assignment algorithm for each link for flexible assignment of queues for links.

On the other hand, the signal detection unit 210 notifies the data control unit 220 of whether the line interface unit is in the state where the loading is possible and generates full signal (FS) and empty signal (ES) for each link upon receiving write pointer (WP) and read pointer (RP) from the queue assignment unit 200 and the data control unit 220 respectively. Then, the signal detection unit 210 transmits the two signals (FS, ES) to the queue assignment unit 200 and the data control unit 220 respectively, giving notice of the queue (201)'s state.

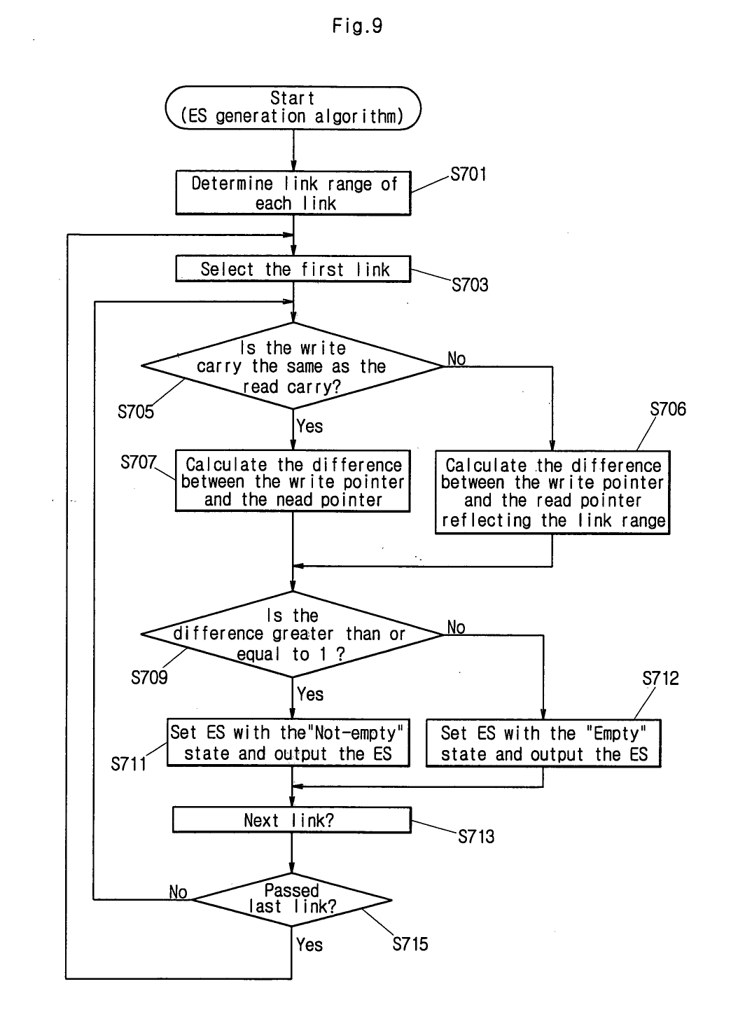

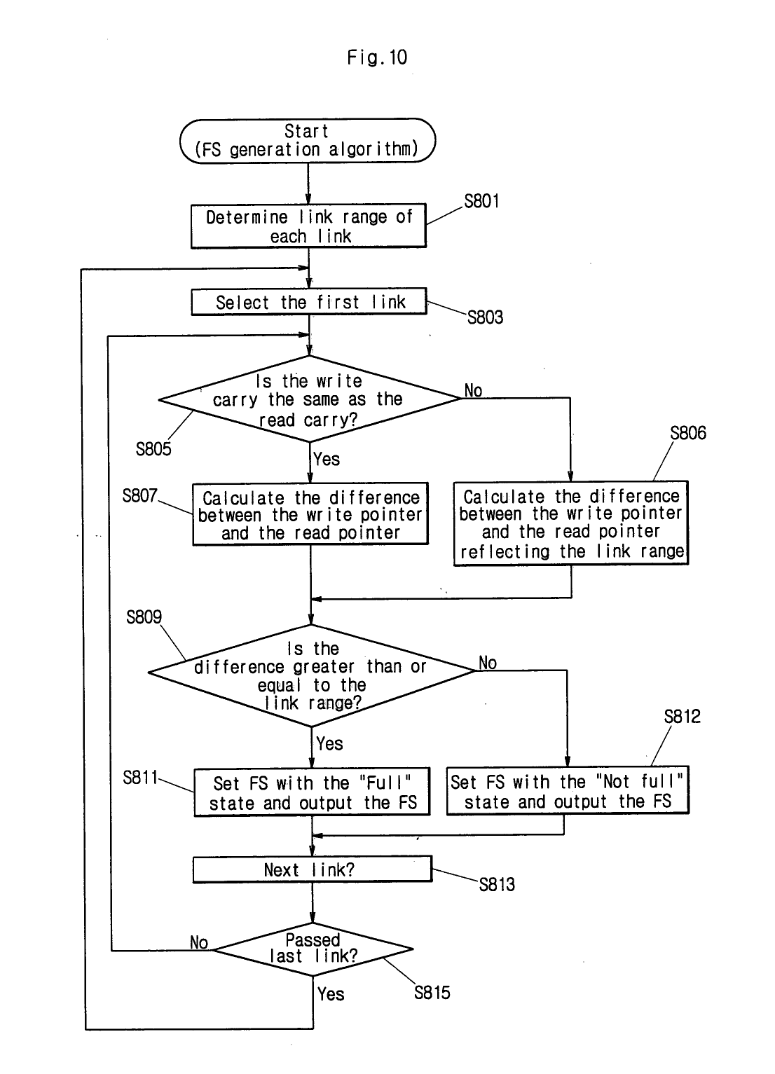

The signal detection unit 210 operates in accordance with the empty signal generation algorithm of FIG. 9 and the full signal generation algorithm of FIG. 10.

First, as shown in FIG. 9, the range of each link is determined (S701). The link range (LR) is the queue size. This indicates how many banks are assigned to each link. The range of each link is determined by using the link's start address (LSA) and the link's end address (LEA). The link range (LR) is the link's end address (LEA) minus the links start address (LSA) plus 1 (i.e., LR=LEA−LSA+1). For example, if LSA(2) and LEA(2) are ‘0001’ and ‘0200’ respectively, LR would be 0100−0001+1. Thus, LR(2) is ‘0100.’

Thereafter, when the link ranges for all of the links are determined, beginning with the first link, the write carry (WC) and the read carry (RC) are compared (S703, S705). If the write carry (WC) and the read carry (RC) are the same, the difference pointer (DP) is obtained by subtracting the read pointer (RP) from the write pointer (WP) (S707). If the write carry (WC) is not the same as the read carry (RC), the difference pointer (DP) is the difference between the write pointer (WP) and the read pointer (RP) reflecting said link range (S706). From the value of the difference pointer (DP), it is determined whether data has been written in the queue 201.

Then, it is determined whether the difference pointer (DP) is greater than or equal to 1 (S709). If the difference pointer (DP) is greater than or equal to 1, the empty signal (ES) indicates the not-empty state. If the difference pointer (DP) is less than 1, the empty signal (ES) indicates the empty state (S711, S712). The empty signal (ES) then is transmitted to the data control unit 220, reporting the writing status of the queue 201.

The above-described operations are repeated until the n'th link is selected. When the last link has been processed, the above-described operations start all over again beginning with the first link (S713, S715).

FIG. 10 is a full signal (FS) generation algorithm of the signal detection unit according to the present invention. The basic steps (S801 to S807) are the same as the steps S701 to S707 of FIG. 9. As shown in FIG. 10, when all of the links from the first link to the last link are set, the write carry (WC) and the read carry (RC) of the first link are compared and the difference pointer is calculated for the case where the write carry and the read carry are the same and in the case where they are different (S806, S807).

Upon comparing the difference pointer and the link range (S809), if the difference pointer is greater than or equal to the link range, the full signal (FS) is set as the full state (S811). If the difference pointer is smaller than the link range, the full signal (FS) is set as the not-full state (S812). The full signal (FS) generated in this step is transmitted to the queue assignment unit 200 to inform the state of the queue 201.

If the full signal (FS) is in the full state, even if there arises data to be written in the queue 201 of the relevant link, the queue assignment unit 200 discards the data. Then, the operation to write data for the next link follows.

The above-described operations are repeated until the n'th link has been processed (S813). When the last link has been processed, the operations are conducted all over again from the first link (S815).

If data is written in the queue 201 according to the above-described operations, the data is read and then written in the line interface unit. For this purpose, the data control unit 220 receives from the signal detection unit 210 the availability of the line interface unit and the empty signal (ES) of the queue 201, reads data from the queue 201 according to said availability signal and the empty signal (ES), and writes the read data in the line interface unit at the same time.

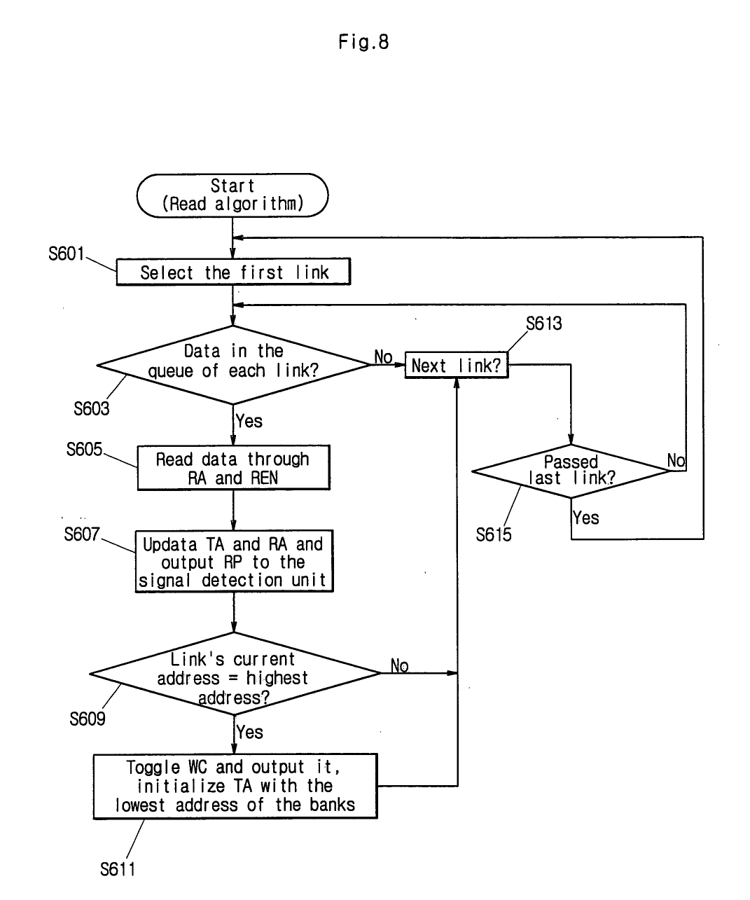

The operations of the data control unit are explained with references to FIG. 8. The data control unit 220 conducts the basic operations according to the read algorithm shown in FIG. 8. The read algorithm of FIG. 7 is the same as the write algorithm of the queue assignment unit 220 in its basic structure. The read algorithm is interrelated to the write algorithm depending on the start and the restart condition.

Different from FIG. 7, in FIG. 8, the read carry (RC) is generated. Also, in order to read data from the queue (201) of each relevant link, the not-empty state of the empty signal (ES) is checked from the first link to the last link (S601, S603, S613, S615). If the relevant link is non-empty, it means that data has been written in the queue. Thus, the data is read through the read address (RA) and read enable signal (REN) (S605). Then, the total address (TA) and the read address are renewed by increasing each relevant address by 1 (S607). Also, the read data is written in the line interface unit 231a˜231n.

Then, the read pointer (RP) is outputted to the signal detection unit 210, transmitting real-time the data that is read from the queue 201 (S607).

Thereafter, it is determined whether the current address is the highest address of the bank. If it is the highest address, the read carry (RC) is toggled and outputted to the signal detection unit 210. The total address (TA) is initialized with the lowest address of the bank (S611). In other words, the combination of the link's end address (LEA) and the lowest bit (ETA=All ‘1’) is the same as the total address. If it is not the same, data is read until the last link has been processed.

In other words, if the non-empty state is detected in a link, the data control unit 220 reads data from the queue 201 through the read address (RA) and the read enable signal (REN) that are connected to the queue 201. The number of data items read at this time is equal to the number of the written data items specified in the queue assignment unit 200.

Then, the read address is increased corresponding to the number of data items. If the reading operation of the specified number of data is completed, the total address is increased by 1.

In order to transmit the read pointer to the signal detection unit 210, the total address is set with the read pointer and it is determined whether the current address reached the highest address. If the total address is the highest address, the read counter is toggled (RC=Not RC) and the total address is initialized with the lowest address of the bank. At this time, the read pointer is transmitted to the signal detection unit 210.

In accordance with another preferred embodiment of the present invention, the queue assignment apparatus and method is applied to a rely line matching board (ALPA-I/LICA-I) which uses the IMA protocol in a CDMA200 1× EV-D0 system of a mobile communication system.

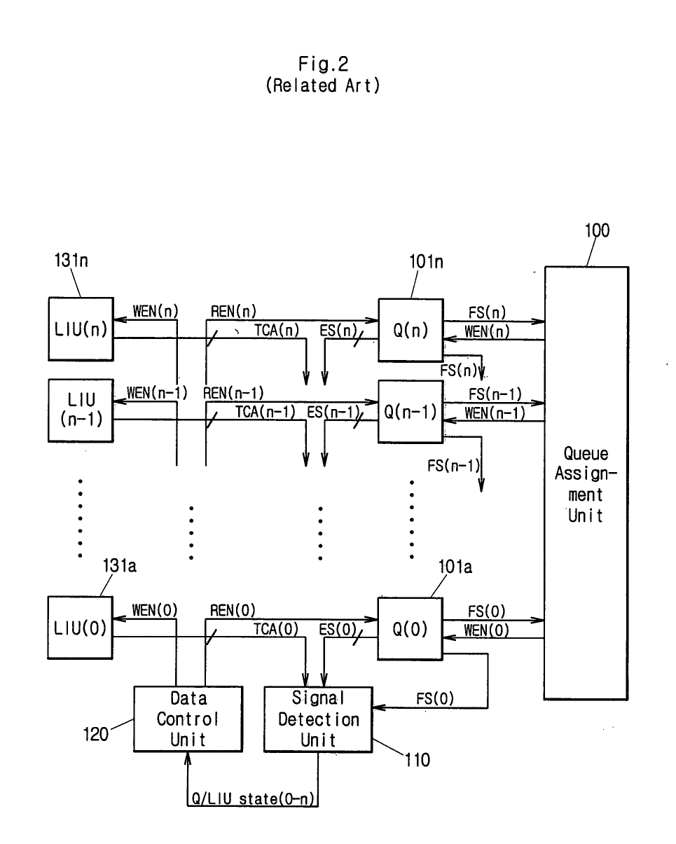

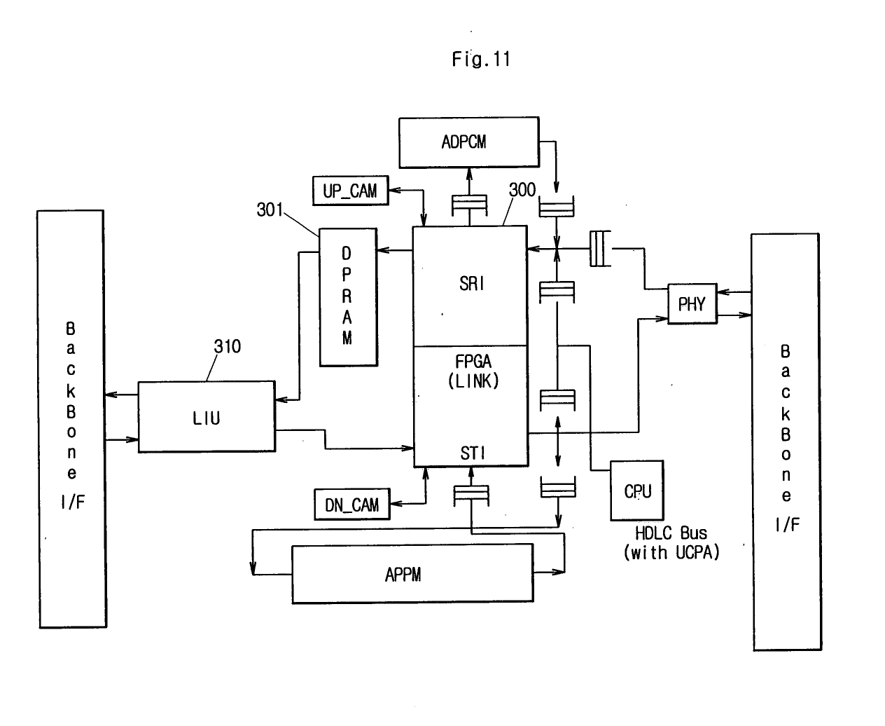

FIG. 11 is a block diagram of the ALPA-I and illustrates the overall structure including the queue's design structure using DPRAM. The structure of LICA-I, which is another board that matches to ALPA-I is the same as the structure of ALPA-I. In FIG. 11, the SRI of FPGA performs the function of the queue assignment unit 100, the signal detection unit 110 and the data control unit 120 of FIG. 2. IMA-16/TC/COMET-QUAD is equivalent to the line interface unit 231a˜231n of the present invention. The backbone interface (BackBone I/F) of FIG. 11 is the part that is actually connected to the links. The SRI of FPGA 300 checks whether there is data to be transmitted to relevant links.

As described above, the present invention has the effect of efficiently assigning queues, managing traffic and preventing link congestion in an access pointer controller having multi-links to multiple access pointers within a mobile communication system. In addition, the present invention has the effect of changing queue assignment for links according to the network state during the link operation.

Further, different from related-art technology which assigns a fixed size of queue to each link of multi-links, the present invention may flexibly assign a variable size of queue to multi-links and reallocate the queue assignment depending on the variable state of the network (e.g., change in the load of each link) during the link operation, thereby preventing the link congestion and efficiently coping with the changes in the network state.

Moreover, the present invention overcomes the disadvantage of the related art where the number of FIFO memories required depends on the number of links. The present invention instead designs the queue with one or more DPRAMs/SRAMs (the number is determined by the designer in consideration of the DPRAM/SRAM capacity). Thus, it is possible to design the queue without regard to fan-out because the bus structure is not used and accordingly the cost is saved.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A queue assignment apparatus for a communications system, comprising:
a queue which stores data for multiple links;
a queue assignment unit that assigns storage banks in the queue to the links;
a signal detection unit that detects availability of a line interface unit; and
a data control unit that reads data from the queue and writes the data in the line interface unit according to the availability of the line interface unit.

2. The apparatus of claim 1, wherein the queue includes one or more DPRAMs or SRAMs.

3. The apparatus of claim 1, wherein the number of banks is based on a combination of address bits used in a memory of the queue.

4. The apparatus of claim 1, wherein said queue assignment unit compares the number of links and the number of banks and assigns at least one bank to each link.

5. The apparatus of claim 1, wherein said signal detection unit generates at least one of an empty signal and a full signal for a bank in the queue corresponding to each link, and reports the state of the bank to the queue assignment unit and the data control unit, the data control unit reading data from and writing data to the bank based on generation of the empty signal or full signal.

6. A queue assignment apparatus in a mobile communication system, comprising:
means for writing data for a plurality of links in a queue of an access pointer controller, the queue including a plurality of banks for storing data for the links;
means for reporting state information indicating whether data has been written into or read from each of the banks in the queue; and
means for writing the data read from one of the banks into a FIFO memory within a line interface unit so that the data may be transmitted to an access pointer.

7. A queue assignment method in a mobile communication system, comprising:
assigning a plurality of banks in a queue to store data for multiple links;
if data is to be written in a specific link, writing the data in the relevant bank based on a write address and a write enable signal;
increasing the address of the queue and transmitting write pointer corresponding to the address to a signal detection unit;
comparing a read pointer and the write pointer and then generating an empty signal or a full signal for transmission to a data control unit; and
depending on availability of a line interface unit and an empty state of the queue, reading data from the queue and writing it in the line interface unit.

8. The method of claim 7, wherein said assigning of banks comprises:
selecting a first link, checking whether the link is in use, and if the link is in use, checking whether a second link is in use and increasing a link count until a last link is checked;
if the first link is not in use, assigning a desired number of banks to the first link and assigning a start address and an end address to the link; and
assigning one or more banks to the second link by increasing a start address and end address of the second link by referring to the end address of the first preceding link.

9. The method of claim 7, wherein the writing step comprises:
initializing address-related parameters of each link from a first link to a last link;
if the initialization is completed through the last link, starting a read algorithm;
checking whether there exists one item of data to be written in the queue beginning with the first link until the last link has been checked;
if there exists data to be written, writing the data using a write address and write enable signal and increasing a total address when the writing is completed;
setting a write pointer with the increased total address, transmitting the write pointer to a signal detection unit and checking whether a current address of the link is the highest address of the bank by referring to the total address; and
if the current address is the highest address, toggling write carry for the next link, assigning the lowest bits to the total address, or if the current address is not the highest address, checking whether there is data for the next link.

10. The method of claim 9, wherein said address-related parameters include a link start address, a link end address, a total address, and a write carry.

11. The method of claim 9, wherein when the current address of the link has not reached the highest address of the bank, if the restart condition arises, said flexible queue assignment method further comprises initializing address-related parameters of each link.

12. The method of claim 7, wherein generating the empty signal comprises:
determining a range of each link;
from the first link to the last link, comparing the write carry and read carry sequentially and calculating a difference between write pointer and read pointer; and
checking existence of data based on the difference of the pointers and generating the empty signal accordingly.

13. The method of claim 12, wherein said range of each link indicates a number of banks assigned to each link and is determined by using a start address and an end address of each link.

14. The method of claim 7, wherein generating the full signal comprises:
determining a range of each link;
from the first link to the last link, comparing the write carry and read carry sequentially and calculating a difference of pointers according to the comparison; and
if the write carry and the read carry are the same, generating the full signal indicating a full or not-full state depending on whether said difference of pointers is within certain user-specified range.

15. The method of claim 14, wherein said difference of pointers is calculated by subtracting the read pointer from the write pointer if the write pointer and the read pointer are the same, or if the write pointer and the read pointer are not the same by calculating the difference of the write pointer and the read pointer reflecting the range of link.

16. The method of claim 7, wherein said reading of data from the queue comprises:
checking whether the empty signal is in the not-empty state from the first link to the last link;
if a link is detected to be in the not-empty state, reading data through read address and read enable signal connected to the queue;
increasing read address and total address by the number of data items that have been read and checking whether the current address of the link is equal to the highest address of the bank; and
if the current address of the link is equal to the highest address, toggling read carry and initializing total address with the lowest address of the bank, thereby moving to a next link.

17. A control system, comprising:
a queue; and
a controller which assigns storage banks in the queue to plurality of data links in a communications system.

18. The system of claim 17, wherein the controller assigns at least one bank in the queue to each one of the links.

19. The system of claim 17, wherein the controller assigns a plurality of banks in the queue to at least one of the links.

20. The system of claim 18, wherein a first bank in the queue stores data from a first link if at least one condition is satisfied.
